(19) United States
(12) Patent Application Publication
(10) Pub. No.: US 2020/0054053 A1
(43) Pub. Date: Feb. 20, 2020

(54) METHOD FOR PREPARING OLIVE LEAF POWDER

(71) Applicants: Longnan Xiangyu Olive Development Co., Ltd., Longnan (CN); Gansu Inspection and Quarantine Science and Technology Research Institute, Lanzhou (CN)

(72) Inventors: Xiaoping ZHOU, Lanzhou (CN); Bo WANG, Lanzhou (CN); Yuhong LIU, Lanzhou (CN); Ajing LIU, Lanzhou (CN); Huijun WANG, Lanzhou (CN); Jianke LI, Lanzhou (CN); Feng JIN, Lanzhou (CN)

(73) Assignees: Longnan Xiangyu Olive Development Co., Ltd., Longnan (CN); Gansu Inspection and Quarantine Science and Technology Research Institute, Lanzhou (CN)

(21) Appl. No.: 16/405,302

(22) Filed: May 7, 2019

(30) Foreign Application Priority Data
Aug. 16, 2018 (CN) 201810936234.5

(51) Int. Cl. A23L 19/00; A23P 10/47

(52) U.S. Cl. CPC A23L 19/01; A23P 10/47; A23V 2002/00; A23V 2300/38; A23V 2300/10; A23V 2300/26; A23V 2300/24; A23V 2300/20

(57) ABSTRACT

The present invention relates to the field of food processing and provides a method for preparing olive leaf powder, including the following steps: pulverizing olive leaves under conditions protected from light to obtain crushed olive leaves; immersing the crushed olive leaves in water, and homogenizing, to obtain an olive-leaf homogenate; pre-freezing the olive-leaf homogenate at a temperature below −16° C. for more than 25 min, and then vacuum freeze-drying to obtain the olive leaf powder; where the vacuum freeze-drying is performed according to the following: the olive-leaf homogenate is heated at a constant rate from the pre-freezing temperature to a drying temperature, and is dried at this temperature for more than 20 min to obtain the olive leaf powder; and the drying temperature is 15-35° C. In the present invention, the olive leaves are subjected to pulverization and homogenization before the freeze drying, such that by changing the sequence of pulverization and freeze-drying, the freeze-drying efficiency is effectively improved and the energy consumption during freeze-drying is reduced, thereby reducing the freeze-drying cost; and the present invention effectively preserves active substances of the olive-leaf powder, such as the total flavonoids and oleuropein, and improves the reconstitution property of the product, thereby effectively achieving a balance between the quality of the olive-leaf powder and the processing cost.

This application claims priority to Chinese patent application number 201810936234.5, filed Aug. 16, 2018, with a title of METHOD FOR PREPARING OLIVE LEAF POWDER. The above-mentioned patent application is incorporated herein by reference in its entirety.

### TECHNICAL FIELD

The present invention relates to the field of food processing, and particularly to a method for preparing olive leaf powder.

### BACKGROUND

With the advancement of science and technology and the development of the economy, people have increasingly higher requirements on food. Although the traditional food processing technology for the purpose of preservation meets the desire of people to consume various animal and plant foods without seasonal and geographical restrictions, the loss of color, aroma, taste, nutrients and natural active ingredients caused by traditional food processing technology, and safety problems caused by excessive dependence on additives, are increasingly concerning and worrisome to consumers. The urgent demand for fast and convenient diets by consumers has greatly increased the demand for dried products.

Olea europaea, known as common olive, is a Chinese traditional local specialty which contains rich flavonoids, polyphenols, reducing sugars, calcium, phosphorus, iron, vitamins and the like nutritional ingredients, and also contains a variety of special nutritional ingredients such as hydroxytyrosol and oleuropein.

The current main processing manner of olive leaves is drying by baking, but drying by baking causes significant loss of heat-sensitive components and other active substances in the olive leaves. Moreover, the biochemical structural changes caused due to drying by baking change the color and flavor of the olive leaves which limits the development of dried olive leaf products.

Vacuum freeze-drying technology is an internationally advanced drying technology that can effectively preserve the nutritional ingredients and natural activities of a substance, and maintain the natural color and aesthetic appearance of a dried product. However, the vacuum freeze-drying processing manner has a high cost, which significantly increases the processing cost of the olive leaf powder, and thus, is not suitable for industrial production.

### SUMMARY

The present invention provides a method for preparing olive leaf powder to solve the problem that the processing cost and product quality of existing olive leaf powder cannot be balanced, where by improving the vacuum freeze-drying condition, energy consumption is effectively saved and cost is reduced, and the olive leaf powder as prepared has a high content of nutritional ingredients, is natural in color, preserves the original flavor of oleo europaea, and has a good reconstitution property.

To solve the above problem, the present invention provides the following technical solution: The present invention provides a method for preparing olive leaf powder, including the following steps:

(1) pulverizing olive leaves to preferably 7-16 mesh under conditions protected from light, to obtain crushed olive leaves;

(2) immersing the crushed olive leaves in water, and homogenizing, to obtain an olive-leaf homogenate;

(3) pre-freezing the olive-leaf homogenate at a temperature preferably below −16° C. for preferably more than 25 min, and then vacuum freeze-drying to obtain the olive leaf powder;

where the vacuum freeze-drying is preferably performed according to the following: the olive-leaf homogenate is heated at a constant rate from the pre-freezing temperature to a drying temperature, and is dried at this temperature for preferably more than 20 min to obtain the olive leaf powder; and

the drying temperature is preferably 15-35° C.

Preferably, the olive leaves are olive leaves picked from February to May.

Preferably, the homogenizing time in step (2) is 3-15 min.

Preferably, the pre-freezing time in step (3) is 25-35 min.

Preferably, the pre-freezing temperature in step (3) is −30° C. to −16° C.

Preferably, the constant rate of temperature increase in step (3) is 3-6° C./h.

Preferably, the drying time in step (3) is 40-80 min.

Preferably, the vacuum degree of the vacuum freeze-drying in step (3) is 100-250 mbar.

Compared with the prior art, the present invention has the following advantages.

The present invention provides a method for preparing olive leaf powder, including the following steps: pulverizing olive leaves to 7-16 mesh under conditions protected from light, to obtain crushed olive leaves; immersing the crushed olive leaves in water, and homogenizing, to obtain an olive-leaf homogenate; pre-freezing the olive-leaf homogenate at a temperature below −16° C. for more than 25 min, and then vacuum freeze-drying to obtain the olive leaf powder; where the vacuum freeze-drying is performed according to the following: the temperature is raised at a constant speed from the pre-freezing temperature to a drying temperature for more than 20 min to obtain the olive leaf powder; and the drying temperature is 15-35° C. In the present invention, the olive leaves are subjected to preliminary pulverization and homogenization before the freeze drying, such that by changing the pulverization and freeze-drying sequence of the material, the freeze-drying efficiency is effectively improved and the energy consumption during freeze-drying is reduced, thereby reducing the freeze-drying cost, and effectively achieving a balance between preservation of active ingredients of the olive leaves and processing cost.

The olive leaves are first freeze-dried. At this time, the olive leaves have an intact structure, and thus the water inside the intact olive leaves can only escape from a vascular bundle; while the crushed olive leaves have increased passages for rapid escape of moisture due to more cross-section layers as compared with those of the intact olive leaves. As a result, the time of pulverizing and then freeze-drying is reduced by 1.5-2.5 h as compared with the process time of direct freeze-drying. That is, for the method provided by the present invention, by adjusting the sequence of the pulverizing and freeze-drying steps, freeze-drying time is effectively saved, thereby reducing the energy consumption and reducing the cost.

In the olive leaf powder obtained by the preparation method provided by the present invention, the nutritional ingredients and biological active ingredients are preserved to the maximum limit, and the water dissolving rate of the nutritional ingredients contained in the olive leaves, such as total polyphenols, total flavonoids, total polysaccharides and oleuropein, is significantly improved from that of the nutritional ingredients obtained by drying by baking.

In the preparation process of the present invention, the biological structure of the olive leaves is kept unchanged, and in particular, the heat-sensitive and readily oxidizable substances are well protected, and thus the loss of heat-sensitive components and other active substances is reduced as compared with the drying by baking method.

The reconstitution property of the olive leaf powder prepared by the method of the present invention is significantly improved compared with those of the olive leaf powder obtained by baking or drying in shade, the quality of the olive leaf powder is greatly improved, and thus the olive leaf powder prepared by the method of the present invention can be used as an excellent raw material for related medical or health care products.

### BRIEF DESCRIPTION OF THE DRAWING

FIG. 1 is a chromatogram of the freeze-dried olive leaf powder prepared in Embodiment 1;

FIG. 2 is a chromatogram of the freeze-dried olive leaf powder prepared in Comparative Example 1;

FIG. 3 is a comparison diagram of FIGS. 1 and 2; and

FIG. 4 is a standard curve of determination of total flavonoids.

### DETAILED DESCRIPTION

The present invention provides a method for preparing olive leaf powder, including the following steps:

(1) pulverizing olive leaves to 7-16 mesh under conditions protected from light, to obtain crushed olive leaves;

(2) immersing the crushed olive leaves in water, and homogenizing, to obtain an olive-leaf homogenate;

(3) pre-freezing the olive-leaf homogenate at a temperature below −16° C. for more than 25 min, and then vacuum freeze-drying to obtain the olive leaf powder;

where the vacuum freeze-drying is performed according to the following: the olive-leaf homogenate is heated at a constant rate from the pre-freezing temperature to a drying temperature, and is preferably dried at this temperature for more than 20 min to obtain the olive leaf powder; and

the drying temperature is preferably 15-35° C.

In the present invention, preferably fresh olive leaves are selected as raw materials, where the fresh olive leaves are preferably olive leaves picked from February to May each year, and more preferably fresh olive leaves collected in April are used as raw materials for preparation. The olive leaves employed in the present invention do not include tender olive leaves, which include fewer active ingredients and thus are not suitable as raw materials for preparation.

In the present invention, the olive leaves are pulverized to 7-16 mesh under conditions protected from light to obtain crushed olive leaves. Pulverizing under conditions protected from light can prevent photosensitive substances in the olive leaves from light decomposition and reduce the loss of active substances.

In the present invention, the particle size of the pulverized olive leaves is preferably 8-12 mesh, and more preferably 10 mesh. In the present invention, pulverizing the olive leaves before freeze-drying has two purposes: first, the crushed olive leaves are more easily dried, which can effectively reduce the cost of vacuum freeze-drying and reduce energy consumption; and second, it can prevent the phenomenon of getting damp or packaging difficulties. For a conventional vacuum freeze-drying process, the olive leaves are freeze-dried and then pulverized, and thus the phenomenon of getting damp or packaging difficulties are liable to occur during pulverization, thereby lowering the quality of the olive leaf powder.

In the present invention, after the crushed olive leaves are obtained, the crushed olive leaves are immersed in water and homogenized, to obtain an olive-leaf homogenate. In the present invention, the crushed olive leaves are immersed in water to prevent the crushed olive leaves from adhering to a homogenizing device. The present invention has no specific limitation on the amount of water used for immersing the crushed olive leaves, as long as the water can immerse the olive leaves.

In the present invention, the homogenizing time is preferably 3-15 min, and more preferably 10 min.

In the present invention, the purpose of homogenizing the olive leaves is to conduct further pulverization, thereby further reducing the energy consumption of vacuum freezing and saving cost.

In the present invention, after the olive-leaf homogenate is obtained, the olive-leaf homogenate is preferably cooled to below −16° C., and then preferably pre-frozen below −16° C. for more than 25 min. After the pre-freezing is completed, the pre-frozen olive-leaf homogenate is preferably heated to a temperature of 15-35° C. at a constant rate, and preferably dried at 15-35° C. for 20 min to obtain an olive leaf powder.

In the present invention, the pre-freezing time is preferably 25-35 min, and the pre-freezing time is calculated from when the olive-leaf homogenate is cooled to the pre-freezing temperature. In the present invention, the pre-freezing temperature is preferably −30° C. to −16° C., and more preferably −25° C. to −20° C. The purpose of pre-freezing in the present invention is to firstly bring the olive-leaf homogenate to the vicinity of a eutectic point (−25° C.), i.e., below −16° C.

In the present invention, the constant temperature rise rate of increasing the temperature from the pre-freezing temperature is preferably 3-6° C./h, and more preferably 5° C./h, and the process of increasing the temperature at a constant rate is for removing free water from the olive leaves. In the present invention, the process of increasing the temperature at a constant rate is preferably performed while increasing the temperature from −25° C. to 20° C.

In the present invention, after the temperature is preferably increased at a constant rate to 15-35° C., the temperature is preferably maintained at 15-35° C. for drying, where the drying time is preferably 40-80 min, and more preferably 60 min; and the drying temperature is more preferably 20° C. The drying stage is used for removing crystal water from the olive leaves, which is a key step in vacuum freeze-drying.

In the present invention, the vacuum degree during the vacuum freeze-drying is preferably 150-250 mbar, and more preferably 200 mbar.

The vacuum freeze-drying time of the olive-leaf homogenate in the present invention requires about 10-16 h from the start of pre-freezing to the end of drying, and thus the freeze-drying time is relatively shorter and the energy consumption of drying is lower than that of a conventional method, and the olive leaf powder can be obtained just after the vacuum freeze-drying, without occurrence of any getting-damp phenomenon.

In the present invention, after the olive leaf powder is obtained, the olive leaf powder is directly packaged, sealed, and stored in a dry environment protected from light.

Upon detection, the olive leaf powder prepared by the present invention has a particle size of about 60 mesh and a water content between 1.8% and 4.2%. The olive leaf powder prepared by the method of the present invention has an oleuropein content of about 3,800 mg/kg, a total flavonoids content up to 22-23 mg/g, and a reconstitution property of 76-78%.

In order to further illustrate the present invention, the technical solution provided by the present invention is described in detail below in connection with embodiments, but these embodiments should not be understood as limiting the claimed scope of the present invention.

### Embodiment 1

1. Raw materials: fresh olive leaves (picked in April), which were marked with “protection of geographical indications Products” and grown in Longnan prefecture, were used as raw materials, with the agricultural residues in the olive leaves meeting relevant health standards.

2. Removal of impurities: withered, yellowed and rotten leaves were removed from the olive leaves, and then the olive leaves were cleaned by washing with water, making them ready for use.

3. Pulverizing: the clean-washed olive leaves were pulverized to 12 mesh by using a pulverizer, to obtain crushed olive leaves.

4. Homogenizing: the crushed olive leaves were placed in a high-speed homogenizer, added with a small amount of water for immersing the crushed olive leaves, and homogenized for 10 min to obtain the olive-leaf homogenate.

5. Pre-freezing stage: a vacuum freeze dryer was turned on to conduct pre-freezing of a divider plate, the olive-leaf homogenate was placed onto the divider plate when the temperature of the divider plate was lowered to −10° C., the chamber door of the vacuum freeze dryer was closed, and the temperature was continually lowered to −25° C. for about 30 min. When the temperature of the olive-leaf homogenate reached −25° C., it was maintained for 20 min.

6. Vacuum freeze-drying stage: after the pre-freezing was completed, the olive-leaf homogenate was completely frozen into a solid state, subsequently a vacuum pump was turned on to vacuumize a material chamber until the vacuum degree reached 200 mbar, after which the vacuum pump started to vacuumize a condensation chamber, and afterwards the divider plate was powered linearly to increase the temperature to 20° C. at a rate of 5° C. per hour, so as to remove free water from the materials. The vacuum degree in each of the material chamber and the condensation chamber was maintained at 150 mbar. The temperature of the condensation chamber was set at −80° C. The freeze-drying was done in 9 hours and thus sublimation was completed. Finally, the temperature of the divider plate was kept at 30° C. for 30 min, and then the freeze-drying process was completed. At this time, the olive-leaf homogenate became olive leaf powder with a water content of 4.0%.

7. After the freeze-drying was completed, the olive leaf powder was removed and passed through a 40-400 mesh for determining particle size, and it was determined that the particle size of the olive leaf powder was 60 mesh.

8. The obtained olive leaf powder was immediately filled with nitrogen or vacuumed, sealed, and stored in a dry environment protected from light.

### Embodiment 2

1. Raw materials: fresh olive leaves (picked in March), which were marked with “protection of geographical indications Products” and grown in Longnan prefecture, were used as raw materials, with the agricultural residues in the olive leaves meeting relevant health standards.

2. Removal of impurities: withered, yellowed and rotten leaves were removed from the olive leaves, and then the olive leaves were cleaned by washing with water, making them ready for use.

3. Pulverizing: the clean-washed olive leaves were pulverized to 16 mesh by using a pulverizer, to obtain crushed olive leaves.

4. Homogenizing: the crushed olive leaves were placed in a high-speed homogenizer, added with a small amount of water for immersing the crushed olive leaves, and homogenized for 12 min to obtain the olive-leaf homogenate.

5. Pre-freezing stage: a vacuum freeze dryer was turned on to conduct pre-freezing of a divider plate, the olive-leaf homogenate was placed onto the divider plate when the temperature of the divider plate was lowered to −10° C., the chamber door of the vacuum freeze dryer was closed, and the temperature was continually lowered to −30° C. for about 30 min. When the temperature of the olive-leaf homogenate reached −30° C., it was maintained for 30 min.

6. Vacuum freeze-drying stage: after the pre-freezing was completed, the olive-leaf homogenate was completely frozen into a solid state, subsequently a vacuum pump was turned on to vacuumize a material chamber until the vacuum degree reached 180 mbar, after which the vacuum pump started to vacuumize a condensation chamber, and afterwards the divider plate was powered linearly to increase the temperature to 24° C. at a rate of 6° C. per hour, so as to remove free water from the materials. The vacuum degree in each of the material chamber and the condensation chamber was maintained at 150 mbar. The temperature of the condensation chamber was set at −80° C. The freeze-drying was done in 9 hours and thus sublimation was completed. Finally, the temperature of the divider plate was kept at 26° C. for 60 min, and then the freeze-drying process was completed. At this time, the olive-leaf homogenate became olive leaf powder with a water content of 3.7%.

7. After the freeze-drying was completed, the olive leaf powder was removed and passed through a 40-400 mesh for determining particle size, and it was determined that the particle size of the olive leaf powder was 60 mesh.

8. The obtained olive leaf powder was immediately filled with nitrogen or vacuumed, sealed, and stored in a dry environment protected from light.

### Embodiment 3

1. Raw materials: fresh olive leaves (picked in May), which were marked with “protection of geographical indications Products” and grown in Longnan prefecture, were used as raw materials, with the agricultural residues in the olive leaves meeting relevant health standards.

2. Removal of impurities: withered, yellowed and rotten leaves were removed from the olive leaves, and then the olive leaves were cleaned by washing with water, making them ready for use.

3. Pulverizing: the clean-washed olive leaves were pulverized to 7 mesh by using a pulverizer, to obtain crushed olive leaves.

4. Homogenizing: the crushed olive leaves were placed in a high-speed homogenizer, added with a small amount of water for immersing the crushed olive leaves, and homogenized for 6 min to obtain the olive-leaf homogenate.

5. Pre-freezing stage: a vacuum freeze dryer was turned on to conduct pre-freezing of a divider plate, the olive-leaf homogenate was placed onto the divider plate when the temperature of the divider plate was lowered to −10° C., the chamber door of the vacuum freeze dryer was closed, and the temperature was continually lowered to −16° C. for about 28 min. When the temperature of the olive-leaf homogenate reached −16° C., it was maintained for 10 min.

6. Vacuum freeze-drying stage: after the pre-freezing was completed, the olive-leaf homogenate was completely frozen into a solid state, subsequently a vacuum pump was turned on to vacuumize a material chamber until the vacuum degree reached 250 mbar, after which the vacuum pump started to vacuumize a condensation chamber, and afterwards the divider plate was powered linearly to increase the temperature to 20° C. at a rate of 4° C. per hour, so as to remove free water from the materials. The vacuum degree in each of the material chamber and the condensation chamber was maintained at 200 mbar. The temperature of the condensation chamber was set at −80° C. The freeze-drying was done in 10 hours and thus sublimation was completed. Finally, the temperature of the divider plate was kept at 30° C. for 45 min, and then the freeze-drying process was completed. At this time, the olive-leaf homogenate became olive leaf powder with a water content of 3.7%.

7. After the freeze-drying was completed, the olive leaf powder was removed and passed through a 40-400 mesh for determining of particle size, and it was determined that the particle size of the olive leaf powder was 60 mesh.

8. The obtained olive leaf powder was immediately filled with nitrogen or vacuumed, sealed, and stored in a dry environment protected from light.

### Comparative Example 1

Preparation of baked olive leaf powder: 50 g olive leaves was accurately weighed, evenly spread in a dish, and placed into and baked in an oven at a temperature of 70-85° C. for 12 hours to obtain the olive leaf powder. At this time, the water content of the olive leaf powder was below 4.0%.

### Embodiment 4

This test conducted comparison of active substance content between the freeze-dried olive leaf powder and the baked olive leaf powder.

The olive leaf powder prepared in Embodiment 1 and the olive leaf powder prepared in Comparative Example 1 were respectively taken for detection by ultra-high performance liquid chromatography. 1.0 g of the olive leaf powder obtained in Embodiment 1 and 1.0 g of the olive leaf powder obtained in Comparative Example 1 were accurately weighed and respectively extracted at 60° C. for 40 min with 20 mL 80% by volume of methanol-aqueous solution as the extraction solvent, then 1.5 mL extracting solution passed through a 0.22 μm membrane, and the filtrate was collected for UHPLC (Ultra High Performance Liquid Chromatography) analysis to determine the oleuropein content therein. The oleuropein content was used as an index to conduct comparison of active substance content between the baked olive leaf powder and the olive leaf powder obtained by the method of the present invention.

Preparation of test solution: 1.0 g of each of freeze-dried and baked olive leaf powder were accurately weighed and respectively extracted at 60° C. for 40 min with 20 mL 80% by volume of methanol-aqueous solution as the extraction solvent, centrifuged at 10,000 r/min for 5.0 min, and then the supernatant was taken and ready for use.

Chromatographic column: BEH (Ethylene Bridged Hybrid) C18 (2.1×50 mm, 1.7 μm); detection wavelength: 280 nm; sample volume: 2.0 μL; mobile phase A was 0.1% (v/v) methanol-formic acid, and mobile phase B was 0.1% (v/v) formic acid-water, gradient elution was conducted, and the elution procedure is shown in Table 1 below; and under this condition, the peaking time of oleuropein was 11.02 min.

TABLE 1
Gradient elution procedure for ultra-
high performance liquid chromatography

| | Flowing | Mobile | Mobile |
|---|---|---|---|
| Time (min) | Rate (mL/min) | Phase A (%) | Phase B (%) |
| 0 | 0.3 | 15 | 85 |
| 7 | | 35 | 65 |
| 20 | | 45 | 55 |
| 21 | | 15 | 85 |
| 25 | | 15 | 85 |

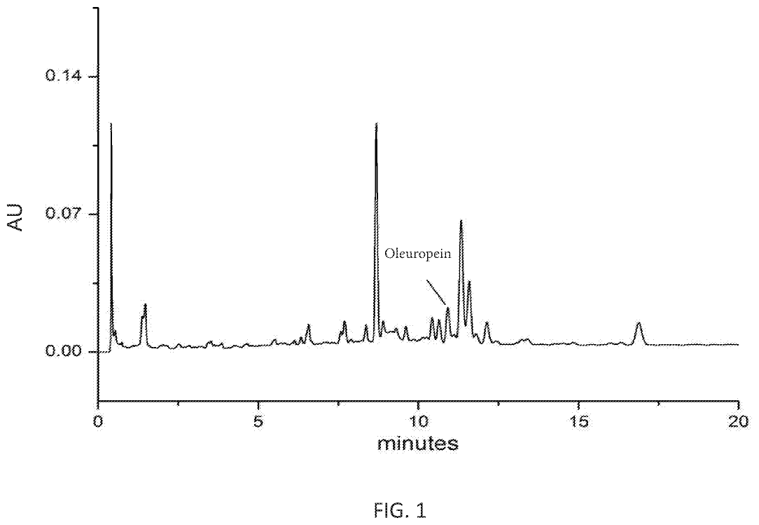

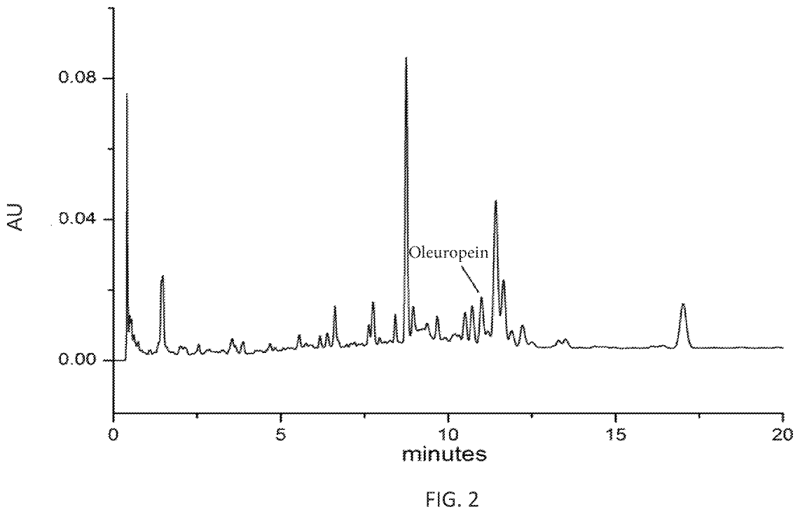

The results of ultra-high performance liquid chromatography are as shown in FIGS. 1 and 2. FIG. 1 is a chromatogram of the freeze-dried olive leaf powder prepared in Embodiment 1, and FIG. 2 is a chromatogram of the baked olive leaf powder prepared in Comparative Example 1.

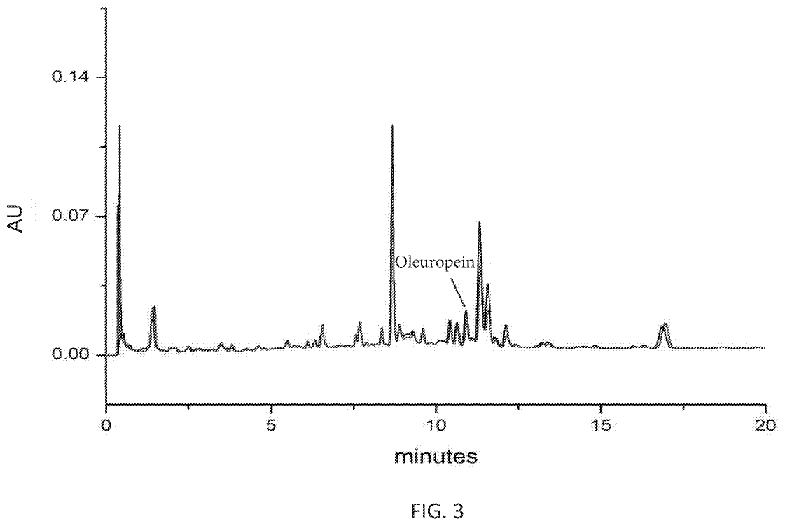

For a more intuitive comparison, the two chromatograms of FIGS. 1 and 2 are superimposed to obtain FIG. 3, where black represents the chromatogram of the freeze-dried olive leaf powder and non-black (blue) represents the chromatogram of the baked olive leaf powder. It can be seen from FIG. 3 that the content of active ingredients in the freeze-dried olive leaf powder is significantly higher than that of the baked olive leaf powder.

The oleuropein content in the freeze-dried olive leaf powder is 3,800 mg/kg, and the oleuropein content in the baked olive leaf powder is 2,600 mg/kg. The preparation method provided by the present invention can effectively preserve the active ingredients of the olive leaves and increase the content of the active ingredients in the finally prepared olive leaf powder.

### Embodiment 5

This test examined the reconstitution property of the olive leaf powder prepared by the present invention.

1 g of each of the olive leaf powder prepared in Embodiment 1 and the olive leaf powder prepared in Comparative Example 1 were respectively taken and they were each mixed with 20 mL distilled water, allowed to stand at 25° C. for 1 h, centrifuged at a rate of 10,000 r/min for 25 min to cause solid-liquid separation, and then the mass of the resultant solid fraction was the mass after reconstitution. The reconstitution property was calculated according to the following equation:

$$Reconstitution property / \% = \frac{{M}_{2} - {M}_{1}}{{M}_{1}} \times 100$$

where, M₁ represents the mass of the olive leaf powder before reconstitution, and M₂ represents the mass of the olive leaf powder after reconstitution.

The results are shown in Table 2, wherein the first three reconstitution property % belong to Embodiment 1 and the next three belong to Comparative Example 1:

TABLE 2
Reconstitution properties of olive leaf powder
obtained by different preparation methods

| Groups | Reconstitution Property (/%) |
|---|---|
| Embodiment 1 | 76 |
| | 78 |
| | 76 |
| Comparative Example 1 | 58 |
| | 62 |
| | 64 |

It can be seen from Table 2 that the reconstitution property of the olive leaf powder (freeze-dried olive leaf powder) prepared in Embodiment 2 is significantly better than that of the olive leaf powder (baked olive leaf powder) prepared in Comparative Example 1, indicating that the preparation method provided by the present invention can effectively improve the reconstitution property of the olive leaf powder, i.e., improving the quality of the olive leaf powder.

### Embodiment 6

This test determined the content of total flavonoids in the olive leaf powder prepared by the present invention and of Comparative Example 1 and compared the two contents.

Determination Procedure of Total Flavonoids:

Extraction: the olive leaf powder prepared in Embodiment 1 and Comparative Example 1 were each mixed with 80% by volume of methanol according to a solid-liquid ratio of 1:16 (g:mL), and then subjected to ultrasonication for 30 min for extraction of the total flavonoids, and the extracting solution of total flavonoids was obtained and ready for use.

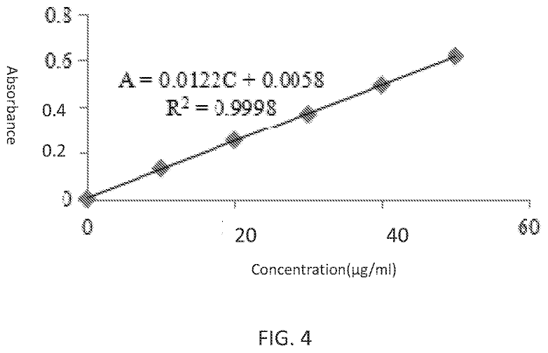

Determination: 20 mg rutin which had been dried to a constant weight at 105° C. was accurately weighed, and the rutin was added with 80% methanol to obtain a volume of 200 mL, so as to obtain a 0.1 mg/mL standard stock solution. 0.0, 1.0, 2.0, 3.0, 4.0 and 5.0 mL of the standard stock solution were each pipetted into a 10 mL centrifuge tube, and 30% by volume of an ethanol solution was added to reach 5.0 mL, then 0.3 mL of a 5% NaNO₂ solution was added, shaken well and allowed to stand for 6 min, subsequently added was 0.3 mL of a 10% AlCl₃ solution and shaken well, allowed to stand for 6 min, afterwards added with 4.0 mL of a 1 mol/L NaOH solution, water to reach 10 mL, and then it was allowed to stand for 15 min, and evaluated for its absorbance at a wavelength of 510 nm by using distilled water as a blank reference. A standard curve of total flavonoids was made by using the mass concentration of rutin (μg/mL) as the horizontal coordinate and using the absorbance as the vertical coordinate, and the depicted standard curve of total flavonoids was as shown in FIG. 4. Appropriate amount of the solution to be determined was taken and determined by the aforementioned method. The calculation equation was as follows:

$$W = \frac{C \times 10 \times N}{V \times 1000}$$

where, W represents the mass concentration of total flavonoids, in mg/mL;

C represents the concentration of a sample solution made up to 10 mL, in μg/mL;

N represents the dilution factor during sample extraction; and

V represents the volume taken for sample determination, in mL.

Results:

Each 0.4 L of the extracting solutions of total flavonoids prepared from the olive leaf powder prepared in Embodiment 1 and Comparative Example 1 were respectively taken, they were analyzed and evaluated according to the aforementioned experimental steps (triplicate determinations), and the contents of total flavonoids in olive leaf powder were calculated according to the equation, and as shown in Table 3, wherein the first three numbers represent results from Embodiment 1 and the last three represent results from the Comparative Example 1.

TABLE 3
Contents of total flavonoids in olive leaf
powder prepared by different methods

| Groups | Total Flavonoids (mg/g) |
|---|---|
| Embodiment 1 | 22.14 |
| | 23.08 |
| | 22.87 |
| Comparative Example 1 | 18.24 |
| | 17.52 |
| | 17.69 |

It can be seen from the data in Table 3 that the olive leaf powder prepared by the method of the present invention has a higher content of total flavonoids and preserves more active ingredients than that of the conventional baking manner.

In view of the above, it can be seen that the olive leaf powder obtained by the vacuum freeze-drying method as provided by the present invention has a better reconstitution property, preserves more active substances, and thus can be used as an olive leaf powder raw material with higher purity. At the same time, the preparation method provided by the present invention effectively avoids the phenomenon of getting damp by adjusting the sequence of pulverization and vacuum freeze-drying, and reduces the energy consumption of freeze-drying, i.e., the preparation cost.

The foregoing descriptions are only preferred implementation manners of the present invention. It should be noted that for a person of ordinary skill in the art, several improvements and modifications may further be made without departing from the principle of the present invention. These improvements and modifications should also be deemed as falling within the protection scope of the present invention.

### ACRONYM AND ABBREVIATION LIST

° C. degrees Celsius
AlCl₃ Aluminum chloride
AU absorbance units

### BEH Ethylene Bridged Hybrid

C the concentration of a sample solution made up to 10 mL, in μg/mL
g gram
h hour
kg kilogram
L liter
M₁ mass of the olive leaf powder before reconstitution
M₂ mass of the olive leaf powder after reconstitution
mbar millibar
mg milligram
min minute
mL milliliter
mm millimeter
mol mole
N the dilution factor during sample extraction
NaNO₂ Sodium nitrite
NaOH Sodium hydroxide
nm nanometer
r revolution

### UHPLC Ultra High Performance Liquid Chromatography

### UV Ultra Violet

V the volume taken for sample determination, in mL
v volume
W the mass concentration of total flavonoids, in mg/mL
μg microgram
μL microliter
μm micrometer

What is claimed is:

1. A method for preparing olive leaf powder, comprising the following steps:
(1) pulverizing olive leaves to 7-16 mesh under conditions protected from light, to obtain crushed olive leaves;
(2) immersing the crushed olive leaves in water, and homogenizing, to obtain an olive-leaf homogenate;
(3) pre-freezing the olive-leaf homogenate at a pre-freezing temperature of below −16° C. for more than 25 min, and then vacuum freeze-drying to obtain the olive leaf powder;
wherein the vacuum freeze-drying is performed according to the following: the olive-leaf homogenate is heated at a constant rate of temperature increase from the pre-freezing temperature to a drying temperature, and is dried at this temperature for more than 20 min to obtain the olive leaf powder; and
the drying temperature is 15-35° C.

2. The method for preparing olive leaf powder of claim 1, wherein the olive leaves are olive leaves picked from February to May.

3. The method for preparing olive leaf powder of claim 1, wherein the homogenizing in step (2) is performed for 3-15 min.

4. The method for preparing olive leaf powder of claim 1, wherein the pre-freezing in step (3) is performed for 25-35 min.

5. The method for preparing olive leaf powder of claim 1, wherein the pre-freezing temperature in step (3) is −30° C. to −16° C.

6. The method for preparing olive leaf powder of claim 4, wherein the pre-freezing temperature in step (3) is −30° C. to −16° C.

7. The method for preparing olive leaf powder of claim 1, wherein the constant rate of temperature increase in step (3) is 3-6° C./h.

8. The method for preparing olive leaf powder of claim 1, wherein in step (3) the olive-leaf homogenate is dried at the drying temperature for 40-80 min.

9. The method for preparing olive leaf powder of claim 7, wherein in step (3) the olive-leaf homogenate is dried at the drying temperature for 40-80 min.

10. The method for preparing olive leaf powder of claim 1, wherein the vacuum freeze-drying in step (3) is performed at a vacuum degree of 100-250 mbar.
